(19) United States
(12) Patent Application Publication
(10) Pub. No.: US 2018/0183908 A1
(43) Pub. Date: Jun. 28, 2018

(54) REVERSE DIRECTION SIGNALLING FOR NEXT GENERATION DMG NETWORKS

(71) Applicant: INTEL IP CORPORATION, SANTA CLARA, CA (US)

(72) Inventors: Solomon TRAININ, Haifa (IL); Carlos CORDEIRO, Portland, OR (US); Ran MOR, Petach-Tikva (IL)

(21) Appl. No.: 15/391,210

(22) Filed: Dec. 27, 2016

(51) Int. Cl. H04L 29/08; H04W 72/04; H04L 29/06

(52) U.S. Cl. CPC H04L 69/324; H04W 88/02; H04L 69/22; H04W 72/04

(57) ABSTRACT

Devices and methods are provided to modify block acknowledgement (BA) and/or block acknowledgement response (BAR) control frames to allow for signalling in the reverse direction (RD) process. The new BA and/or BAR control frame uses previously unused fields that are ignored in directive multi-gigabit (DMG) and enhanced DMG (EDMG) networks. The unused fields are repurposed to include a RD Grant (RDG) and an indication that an aggregated media access control (MAC) protocol data unit (MPDU) (A-MPDU) will follow (the indication is referred to as a More PPDU). The change in the BA and/or BAR frame(s) eliminates the need to send a quality of service (QoS) null frame that is typically sent with the BA and/or BAR frame(s), which improves the efficiency of the RD protocol.

### TECHNICAL FIELD

An exemplary aspect is directed toward communications systems. More specifically an exemplary aspect is directed toward wireless communications systems and even more specifically to IEEE (Institute of Electrical and Electronics Engineers) 802.11 wireless communications systems. Even more specifically, exemplary aspects are at least directed toward one or more of IEEE (Institute of Electrical and Electronics Engineers) 802.11/ad/ay . . . communications systems and in general any wireless communications system or protocol, such as 4G, 4G LTE, 5G and later, and the like.

### BACKGROUND

Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

Reverse direction (RD) is a wireless feature that is used under circumstances of low latency bidirectional traffic that can be used for transmission control protocol (TCP), wireless gigabit (WiGig) bus extension (WBE), WiGig serial bus extension (WSE), and WiGig display extension (WDE). RD enables a flexible sharing of bidirectional bandwidth (BW) without limiting transmission opportunities (TxOPs) to short intervals, and therefore may manage the air medium more efficiently.

The RD protocol defines two entities: an RD initiator and an RD responder. A substantial part of the RD protocol is the signaling of a RD Grant (RDG) and an indication that a physical layer convergence procedure (PLCP) protocol data unit (PPDU) will follow (the indication is referred to as a More-PPDU). The RDG/More PPDU are used to provide the RDG, to the RD responder, and notices the RD initiator that the delivery of multiple PPDUs will follow as part of the provided RD opportunity. RDG is provided with frames sent by the RD initiator that may be a data frame, a block acknowledgement (BA) request (BAR) frame, and/or an add BA frame. More PPDU is signaled by a data frame and the BA frame is sent by the RD responder.

The BA frame plays a specific and very important role in the RD protocol. It is the first frame transmitted in the RD sequence sent by the RD responder. The BA frame is sent by basic PHY rate or by a modulation and coding scheme (MCS) in directive multi-gigabit (DMG) and enhanced DMG (EDMG) networks because that procedure is the most reliable way to deliver the BA and is also convenient to share the network allocation vector (NAV) with third party stations. Unfortunately, there is no RDG/More PPDU signaling in BA or BAR frames which requires the use of less efficient signaling for RDG/More PPDU.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an embodiment of an environment for conducting RD transmissions;

FIG. 2 is a schematic illustration of a signaling process for an RD session;

FIG. 3A illustrates an embodiment of a data structure for providing a RDG/More PPDU in a BA frame;

FIG. 3B illustrates an embodiment of a data structure for providing a RDG/More PPDU in another frame;

FIG. 3C illustrates an embodiment of a data structure for providing a RDG/More PPDU in another frame;

FIG. 4 is a flowchart outlining an exemplary technique for conducting a more efficient RD session;

FIG. 5 is a flowchart outlining an exemplary technique for conducting a more efficient RD session; and

FIG. 6 is an illustration of the hardware/software associated with a STA and/or AP.

### DESCRIPTION OF EMBODIMENTS

The embodiments presented herein provide for more efficient signaling of RDG/More PPDU in BA and BAR frames. Typically, in directional multi-gigabit (DMG) networks used in Wi-Fi, one subfield in the quality of service (QoS) control field is used to signal an RDG and a More PPDU. The QoS control field is present in QoS data and QoS null frames but is not present in control frames like BA and BAR, and is also not presented in Add Block-ACK (ADDBA) management frames.

The lack of the RDG/More PPDU subfield in the aforementioned BA, BAR, and/or ADDBA frames is typically resolved by sending an aggregated media access control (MAC) protocol data unit (MPDU) (A-MPDU) that combines a BA or BAR frame with a QoS null frame. This allows using the QoS Control field of the QoS Null frame to signal an RDG/More PPDU. However, the A-MPDU generally requires a BA frame and a QoS null frame in the response to the A-MPDU. Such an aggregation of the BA frame and the QoS null frame introduces an overhead in BA delivery that is about 1 us under MCS 1 requirements and about 300 ns under MCS 4 requirements. As described above, this overhead is the result of the lack of RDG/More PPDU signaling in BA/BAR frames.

The embodiments herein provide a modified or new BA and/or BAR control frame. The BA and/or BAR control frame uses previously unused fields that are ignored in DMG and EDMG. For example, as will be explained further below, the HTC/Order subfield can be used to signal RDG/More PPDU.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE802.11-ay (P802.11 ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.5, August 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

Some demonstrative embodiments may be used in conjunction with a WLAN, e.g., a WiFi network. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 Ghz and 300 GHZ, a WLAN frequency band, a WPAN frequency band, a frequency band according to the WGA specification, and the like.

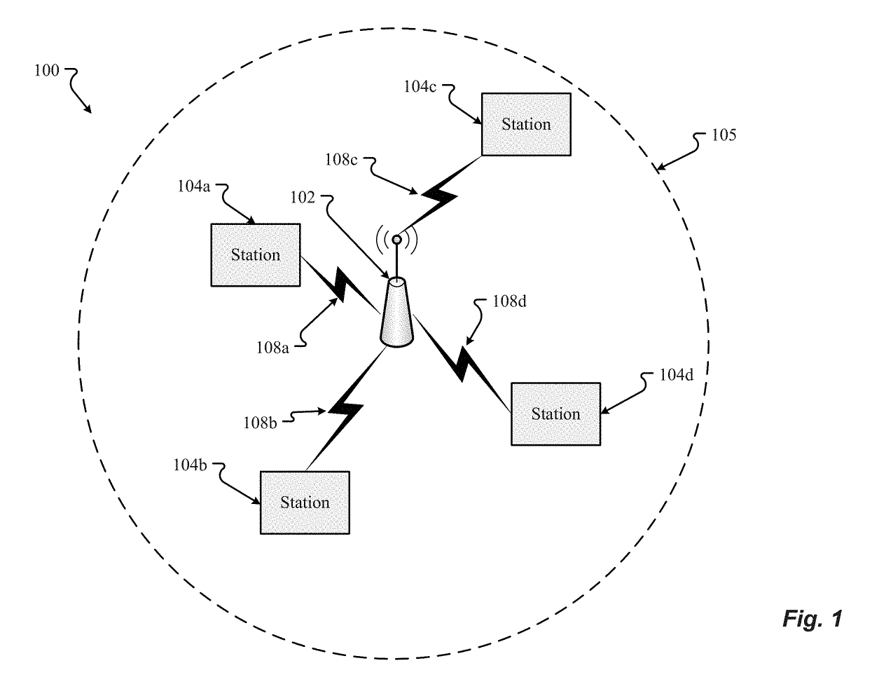

FIG. 1 illustrates an example of an operating environment 100 which may be representative of various configurations described herein. The WLAN 105 may comprise a basic service set (BSS) that may include a master station 102 and one or more other stations (STAs) 104. The master station 102 may be an access point (AP) using the IEEE 802.11 to transmit and receive. Hereinafter, the term AP will be used to identify the master station or STA B 102 (also referred to as the second STA). The AP 102 may be a base station and may use other communications protocols as well as the IEEE 802.11 protocol. The IEEE 802.11 protocol may be the IEEE 802.11ax/ay or later standard. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO).

The STAs 104 may include one or more high-efficiency wireless (HEW) (as illustrated in, e.g., the IEEE 802.11ax standard and/or other current or future IEEE 802.11 standard) STAs 104 a, b, d and/or one or more legacy (as illustrated in, e.g., the IEEE 802.11n/ac standards) STAs 104c. The legacy STAs 104c may operate in accordance with one or more of IEEE 802.11 a/b/g/n/ac/ad/af/ah/aj, or another legacy wireless communication standard. The HEW STAs 104 a, b, d may be wireless transmit and receive devices, for example, a cellular telephone, a smart telephone, a handheld wireless device, wireless glasses, a wireless watch, a wireless personal device, a tablet, or another device that may be transmitting and receiving using a IEEE 802.11 protocol, for example, the IEEE 802.11ax or another wireless protocol. In the operating environment 100, an AP 102 may generally manage access to the wireless medium in the WLAN 105.

Within the environment 100, one or more STAs 104a, 104b, 104c, 104d may associate and/or communication with the AP 102 to join the WLAN 105. Joining the WLAN 105 may enable STAs 104a-104d to wirelessly communicate with each other via the AP 102, with each other directly, with the AP 102, or to another network or resource through the AP 102. In some configurations, to send data to a recipient (e.g., STA 104a), a sending STA (e.g., STA 104b) may transmit an uplink (UL) PPDU comprising the data to AP 102, which may then send the data to the recipient STA 104a, in a downlink (DL) PPDU.

As background, the RD protocol allows for more efficient transfer of data between two STAs, during a TxOP, by eliminating the need for either device to initiate a new data transfer. Hereinafter, the AP 102 will be described as the RD initiator or originator and the STA 104a as the RD responder. A TxOP owner 102 can signal another STA 104a to transfer data to the TxOP owner 102 during that STAs 102 TxOP. Before the RD protocol, data transfer was uni-directional and required the sending STA to contend and capture the wireless medium. With RD, the transmitting STA that has obtained a TxOP can grant permission to another STA 104a to send information back during the STA's TxOP.

The RD procedure requires a RD initiator 102 and a RD responder 104a. The RD initiator 102 provides permission to transmit, to the RD responder 104a, with the RDG in the RDG/More-PPDU subfield in the medium access control (MAC) frame. A similar RDG/More PPDU bit or bits can be sent, to the RD initiator 102a by the RD responder 104a, to signal whether the RD responder 104a will send data back to the RD initiator 102a. These two STAs 102, 104a may conduct an RD session using modified signaling as explained below.

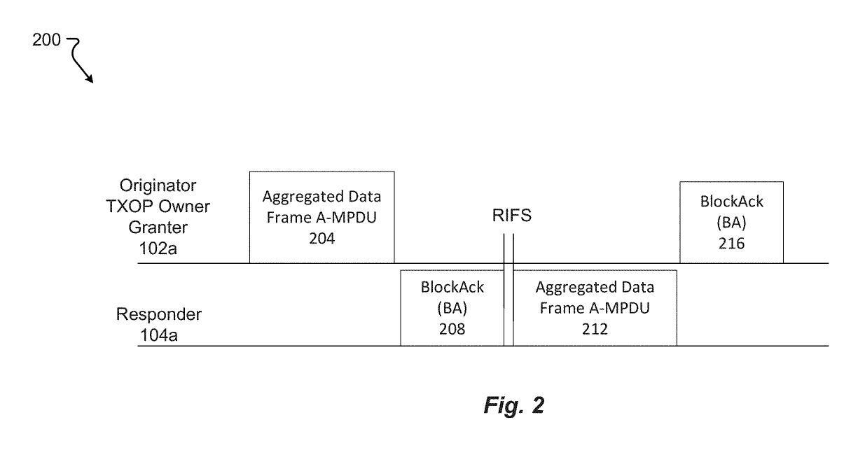

FIG. 2 is a schematic illustration of an RD communication session 200 including an exchange of RDG/More PPDU bits. For example, as shown in FIG. 2, a first STA (“the RD initiator”), e.g., AP 102, may transmit an aggregated data frame (an A-MPDU containing one or more MPDUs such as QoS data frames) 204 to a second STA (“the RD responder). e.g., device 104a. The A-MPDUA-MPDU 204 can set a RDG/More PPDU bit to 1 to signal that the RD responder 104a is being granted permission to use the TxOP to transmit data. The RDG/More PPDU bit may be included in the QoS control field of an A-MPDUA-MPDU 204. Further, the ACK policy bit, in the A-MPDUA-MPDU 204, may also be set to 1 requiring the RD responder 104a to send an immediate BA response.

Thus, the RD responder 104a can reply with a BA frame 208. Here, the proposed BA frame 208 eliminates the QoS null frame that would normally accompany the BA frame 208 in the RD protocol. Rather, a new RDG/More PPDU field (e.g., the previously unused HTC/Order field in the BA frame) is set to 1 if the RD responder 104a will send data thereinafter during the TxOP in response to the A-MPDUA-MPDU 204. Thus, the RDG/More PPDU bit signals that data frames will follow the BA frame 208. With this new RDG/More PPDU bit in the BA frame 208, the QoS null frame is eliminated, thus making the proposal more efficient.

After a reduced interframe space (RIFS), the RD responder 104a can send a A-MPDUA-MPDU frame 212 that includes at least one PPDU (i.e., data). As with the A-MPDUA-MPDU frame 204, a More PPDU bit may be set to 0 to signal that the RD responder 104a will not send more data during the TxOP. The RDG/More PPDU bit may be included in the QoS control field of the A-MPDUA-MPDU 212. Further, another ACK policy bit, in the A-MPDUA-MPDU 212, may also be set to 1 requiring the RD initiator 102 send an immediate BA response. The RD initiator 102 can then send a BA frame 216 to acknowledge receipt of the A-MPDUA-MPDU 212.

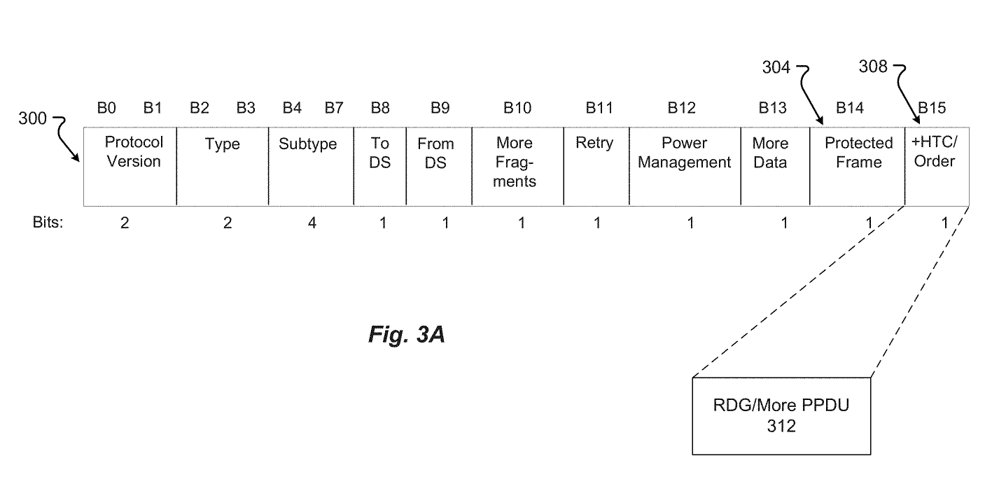

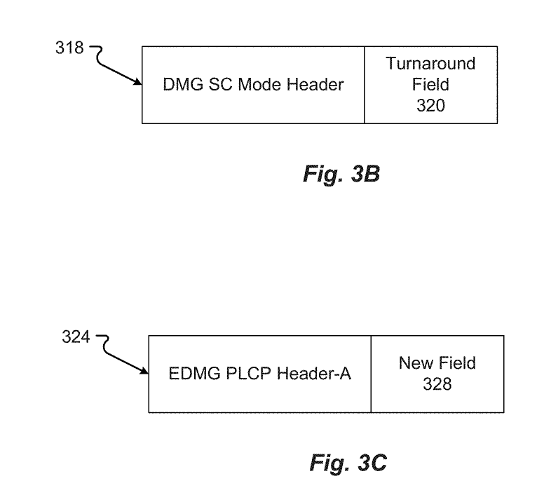

The data structure 300, which can represent a BA frame 208, may be as shown in FIG. 3A. The data structure 300 can be a frame that is transmitted, stored, and/or received by the various devices 102, 104 described herein. The BA data structure 300 can include one or more unused fields that are not used for the RD protocol and are generally ignored during an RD session. For example, the protected frame field 304 and/or the HTC/Order field 308 are not currently pertinent to the RD procedure in DMG 01 EDMG. Either of these fields can be repurposed into an RDG/More PPDU field 312. The RDG/More PPDU field 312 can store the RDG/More PPDU bit explained above to alert the RD initiator 102 that data frames, e.g., A-MPDUA-MPDU 212, will follow the BA frame 208. In other words, field 304 or field 308 become the RDG/More PPDU field 312 that signals the RD initiator 102 that the RD responder 104a will be sending data during the TxOP after a RIFS.

Other data structures 318 and 324 are also provided in FIGS. 3B and 3C. These frames 318 and 324 provide alternatives to repurposing the protected frame field 304 and/or the HTC/Order field 308 in the BA frame 208. In a first alternative, a turnaround field 320 in the DMG Single Channel (SC) Mode Header 318 can be repurposed into the RDG/More PPDU field 312. For example, the More PPDU is equal to 1 if the turnaround field 320 is set to 0, and the MMPDU is equal to 0 if the turnaround field 320 is set to 1. In another alternative, a new field 328 in the EDMG PLCP Header-A 324 can be used as RDG/More PPDU field 312. The EDMG PLCP Header-A 324 is common for any EDMG frames sent over MIMO, MU-MIMO, channel bonding, and/or all supported MCSs. As in the example above, the More PPDU can be equal to 1 if the field 328 is set to 0, and the MMPDU can be equal to 0 if the field 328 is set to 1. Still further, a field in a directive multi-gigabit (DMG) control mode header can be used for the RDG/More PPDU field 312. Thus, other frames and fields may be used to set the RDG/More PPDU bit to eliminate the inefficient transmission of the QoS null frame.

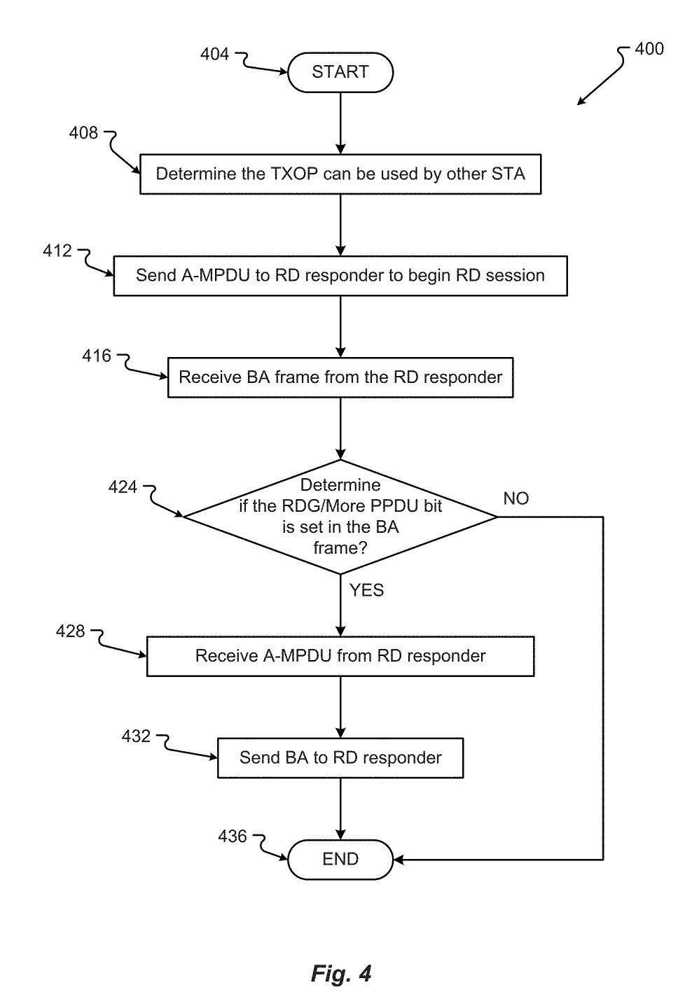

A process 400, conducted by the AP 102 (the RD initiator) and STA 104a (the RD responder), for conducting a more efficient RD session may be as shown in FIG. 4. A general order for the steps of the method 400 is shown in FIG. 4. Generally, the method 400 starts with a start operation 404 and ends with operation 436. The method 400 can include more or fewer steps or can arrange the order of the steps differently than those shown in FIG. 4. The method 400 can be executed as a set of computer-executable instructions executed by a computer system or processor and encoded or stored on a computer readable medium. In other configurations, the method 400 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 400 shall be explained with reference to the systems, components, circuits, modules, software, data structures, signalling processes, etc. described in conjunction with FIGS. 1-3C and 6.

A STA, e.g., AP 102, “the RD initiator”, determines if a transmit opportunity (TxOP) is available for RD signalling. The STA 102 may have contended and obtained a TxOP. However, controller 620 of the STA 102 can determine that the TxOP is not needed to send data. As such, the controller 620 may recognize that the TxOP can be used for RD signalling.

The controller 620 may then generate a A-MPDUA-MPDU frame 204 that can be sent to another STA, e.g. STA 104a, “the RD responder,” in step 412. The controller 620 can generate the A-MPDUA-MPDU frame 204 with a RDG/More PPDU bit set to 1 in the QoS field. This bit signals that the RD initiator 102 is providing an RDG to the RD responder 104a. The A-MPDUA-MPDU frame 204 can be provided to the radio frequency (RF) components (including one or more of, but not limited to, the receiver 668, the transmitter 664, the MAC module 660, and/or the PHY module 656). The RF components can transmit the A-MPDUA-MPDU frame 204 to the RD responder 104a over the wireless medium.

The RD responder 104a can receive the A-MPDUA-MPDU frame 204 and respond with a BA frame 208, which may be received by the RD initiator 102, in step 416. Thus, the RF components can receive the signal with the BA frame 208 over the wireless medium and provide the BA frame 208 to the controller 620. The controller 620 can then evaluate or determine whether a RDG/More PPDU bit, in the RDG/More PPDU field 312, is set to 1, in step 424. It should be noted that the RD responder 104a can send the RDG/More PPDU bit in a DMG SC Mode header 318, in an EDMG PLCP Header-A 324, or in another existing frame. As such, the RD initiator 102 may check if the RDG/More PPDU bit is set in the turnaround field 320 of in the field 328.

If the RDG/More PPDU bit 312 is not set, the method 400 proceeds “NO” to end step 436, where the RD session is concluded. If the RDG/More PPDU bit 312 is set, the method 500 proceeds “YES” to step 428. In step 428, the RD initiator 102 receives an A-MPDU frame 212 from the RD responder 104a, as indicated by the RDG/More PPDU bit 312. The RF components can receive and process the A-MPDU frame 212 before sending the data in the A-MPDU frame 212 to the controller 620. The controller 620 can then perform various functions on the data.

Further, the controller 620, of the RD initiator 102, can then generate BA frame 216, The BA frame 216 acknowledges receipt of the A-MPDU frame 212. The controller 620 sends the BA frame 216 to the RF components, which transmit the BA frame 216 to the RD responder 104a over the wireless medium, in step 432.

It should be noted that the method 400 may be conducted within a single TxOP. Further, the method 400 excludes the transmission of a QoS null frame from the RD responder 104a to the RD initiator 102 in response to receiving the A-MPDU frame 204. As such, the exchange of control information in the RD process is greatly enhanced and the RD process is more efficient and less bandwidth intensive.

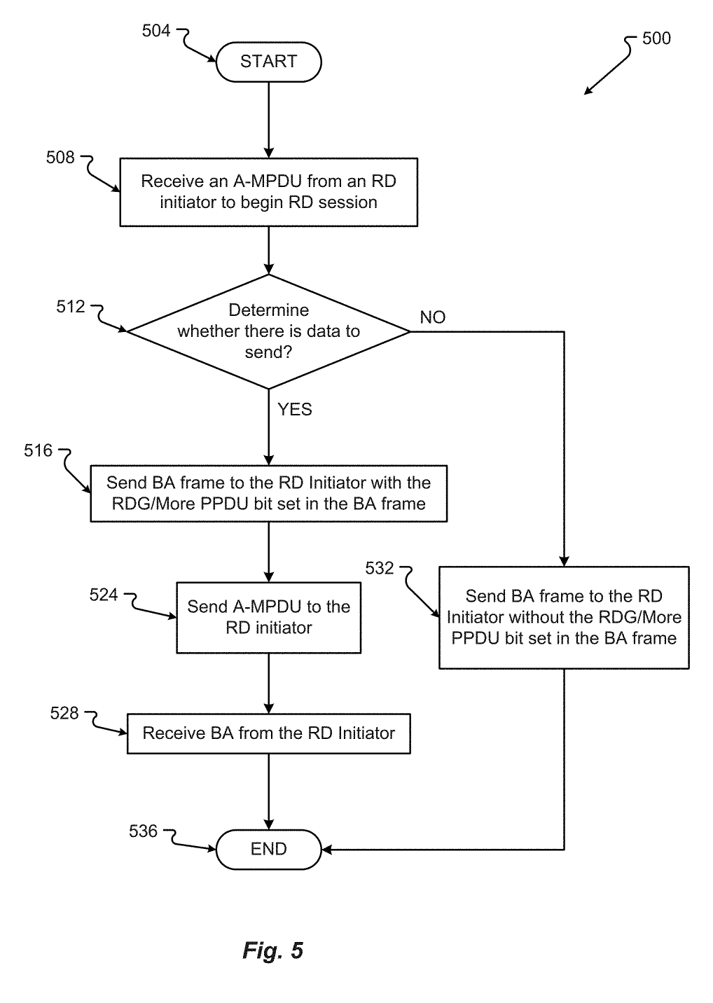

Another process 500, conducted by the STA 104, conducting an RD system may be as shown in FIG. 5. A general order for the steps of the method 500 is shown in FIG. 5. Generally, the method 500 starts with a start operation 504 and ends with operation 536. The method 500 can include more or fewer steps or can arrange the order of the steps differently than those shown in FIG. 5. The method 500 can be executed as a set of computer-executable instructions executed by a computer system or processor and encoded or stored on a computer readable medium. In other configurations, the method 400 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 500 shall be explained with reference to the systems, components, circuits, modules, software, data structures, signalling processes, etc. described in conjunction with FIGS. 1-4 and 6.

A STA, e.g., STA 104a, “the RD responder”, receives an A-MPDU frame 204 that can be sent from another STA, e.g. AP 102, “the RD initiator,” in step 508. The A-MPDU frame 204 can be received as a signal at the radio frequency (RF) components (including one or more of, but not limited to, the receiver 668, the transmitter 664, the MAC module 660, and/or the PHY module 656) from the RD initiator 102 over the wireless medium. The RF components can send the A-MPDU frame 204 to the controller 620.

The controller 620 can read the A-MPDU frame 204 and recognize that the RDG/More PPDU bit set to 1 in the QoS field. This bit signals that the RD initiator 102 is providing an RDG to the RD responder 104a. The controller 620 of the RD responder 104a can then determine if there is data to send, in step 512. The controller 620 can determine if data has been received and/or queued from another data source (e.g., an application, process, other device, etc.). If the data is ready to send, the method 500 proceeds “YES” to step 516. If there is no data to send or the data is not ready to be sent, the method 500 proceeds “NO” to step 532.

In step 516, the controller 620 of the RD responder 104a can generate a BA frame 208. The controller 620 can set a RDG/More PPDU bit, in the RDG/More PPDU field 312. Setting the RDG/More PPDU bit 312 indicates that the RD responder 104a will send an A-MPDU frame 212 to the RD initiator 102 in response to the RDG. It should be noted that the RD responder 104a may also send the RDG/More PPDU bit 312 in a DMG SC Mode header 318, in an EDMG PLCP Header-A 324, or in another existing frame. As such, the RD responder 104a can set the RDG/More PPDU bit 312 in the turnaround field 320 or in the field 328.

The BA frame 208 may then be provided to the RF components to transmit, over the wireless medium, to the RD initiator 102, in step 524. The controller 620 can assemble the data into the A-MPDU frame 212, which may be sent to the RD initiator 102 by the RF components, in step 524.

If no data is to be sent in an A-MPDU frame 212, the controller creates a BA frame 208 without the RDG/More PPDU bit 312 being set. This BA frame 208 may be sent to the RF components and transmitted wirelessly, in step 532. Then, the RD session ends.

Further, the controller 620 of the RD responder 104a can then receive the BA frame 216, in step 528. The BA frame 216 acknowledges receipt of the A-MPDU frame 212. The controller 620 receives the BA frame 216 from the RF components, which can determine that the RD initiator 102 received the A-MPDU frame 212.

It should be noted that the method 500 may be conducted within a single TxOP. Further, the method 500 excludes the transmission of a QoS null frame from the RD responder 104a to the RD initiator 102 in response to receiving the A-MPDU frame 204. As such, the exchange of control information in the RD process is greatly enhanced and the RD process is more efficient and less bandwidth intensive.

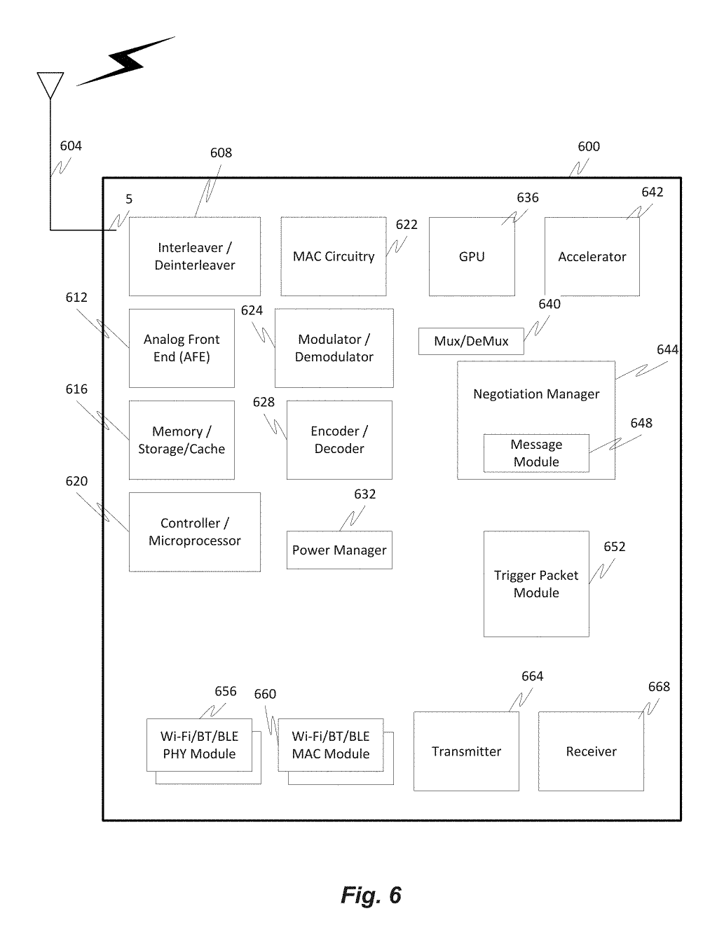

FIG. 6 illustrates an exemplary hardware diagram of a device 600, such as a wireless device, mobile device, access point, station, and/or the like, that is adapted to implement the technique(s) discussed herein. Operation will be discussed in relation to the components in FIG. 6 appreciating that each separate device in a system, e.g., station, AP, proxy server, etc., can include one or more of the components shown in the figure, with the components each being optional.

In addition to well-known componentry (which has been omitted for clarity), the device 600 includes interconnected elements (with links 5 omitted for clarity) including one or more of: one or more antennas 604, an interleaver/deinterleaver 608, an analog front end (AFE) 612, memory/storage/cache 616, controller/microprocessor 620, MAC circuitry 622, modulator/demodulator 624, encoder/decoder 628, power manager 632, GPU 636, accelerator 642, a multiplexer/demultiplexer 640, a negotiation manager 644, message module 648, trigger packet module 652, and wireless radio components such as a Wi-Fi/BT/BLE PHY module 656, a Wi-Fi/BT/BLE MAC module 660, transmitter 664 and receiver 668. The various elements in the device 600 are connected by one or more links (not shown, again for sake of clarity). As one example, the negotiation manager 644 and message module 648 can be embodied as a process executing on a processor or controller, such as processor 620 with the cooperation of the memory 616. The negotiation manager 644 and message module 648 could also be embodied as an ASIC and/or as part of a system on a chip. In some configurations, there can be multiple instances of the PHY Module/Circuitry 656, MAC circuitry 622, transmitter 664, and/or receiver 668, wherein each instance of the PHY Module/Circuitry 656, MAC circuitry 622, transmitter 664, and/or receiver 668 sends/receives data over a specific band (e.g., 2.45 GHz, 915 MHz, 5.2 GHz, etc.) to facilitate multi-band transmissions.

The device 600 can have one more antennas 604, for use in wireless communications such as multi-input multi-output (MIMO) communications, multi-user multi-input multi-output (MU-MIMO) communications Bluetooth®, LTE, RFID, 4G, LTE, etc. The antenna(s) 604 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 604 generally interact with the Analog Front End (AFE) 612, which is needed to enable the correct processing of the received modulated signal and signal conditioning for a transmitted signal. The AFE 612 can be functionally located between the antenna and a digital baseband system to convert the analog signal into a digital signal for processing and vice-versa.

The device 600 can also include a controller/microprocessor 620 and a memory/storage/cache 616. The device 600 can interact with the memory/storage/cache 616 which may store information and operations necessary for configuring and transmitting or receiving the information described herein. The memory/storage/cache 616 may also be used in connection with the execution of application programming or instructions by the controller/microprocessor 620, and for temporary or long term storage of program instructions and/or data. As examples, the memory/storage/cache 620 may comprise a computer-readable device, RAM, ROM, DRAM, SDRAM, and/or other storage device(s) and media.

The controller/microprocessor 620 may comprise a general purpose programmable processor or controller for executing application programming or instructions related to the device 600. Furthermore, the controller/microprocessor 620 can perform operations for configuring and transmitting information as described herein. The controller/microprocessor 620 may include multiple processor cores, and/or implement multiple virtual processors. Optionally, the controller/microprocessor 620 may include multiple physical processors. By way of example, the controller/microprocessor 620 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 600 can further include a transmitter 664 and receiver 668 which can transmit and receive signals, respectively, to and from other wireless devices and/or access points using the one or more antennas 604. Included in the device 600 circuitry is the medium access control or MAC Circuitry 622. MAC circuitry 622 provides for controlling access to the wireless medium. In an exemplary embodiment, the MAC circuitry 622 may be arranged to contend for the wireless medium and configure frames or packets for communicating over the wireless medium.

The PHY Module/Circuitry 656 controls the electrical and physical specifications for device 600. In particular, PHY Module/Circuitry 656 manages the relationship between the device 600 and a transmission medium. Primary functions and services performed by the physical layer, and in particular the PHY Module/Circuitry 656, include the establishment and termination of a connection to a communications medium, and participation in the various process and technologies where communication resources shared between, for example, among multiple STAs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 656 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 622 handle co-ordination of interactions between the MAC and PHY layers.

The interleaver/deinterleaver 608 cooperates with the various PHY components to provide Forward Error correction capabilities. The modulator/demodulator 624 similarly cooperates with the various PHY components to perform modulation which in general is a process of varying one or more properties of a periodic waveform, referred to and known as a carrier signal, with a modulating signal that typically contains information for transmission. The encoder/decoder 628 manages the encoding/decoding used with the various transmission and reception elements in device 600.

The MAC layer and components, and in particular the MAC module 660 and MAC circuitry 622 provide functional and procedural means to transfer data between network entities and to detect and possibly correct errors that may occur in the physical layer. The MAC module 660 and MAC circuitry 622 also provide access to contention-based and contention-free traffic on different types of physical layers, such as when multiple communications technologies are incorporated into the device 600. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 600 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 642 can cooperate with MAC circuitry 622 to, for example, perform real-time MAC functions. The GPU 636 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure. In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrases “directional multi-gigabit (DMG)” and “directional band” (DBand), as used herein, may relate to a frequency band wherein the Channel starting frequency is above 45 GHz. In one example, DMG communications may involve one or more directional links to communicate at a rate of multiple gigabits per second, for example, at least 1 Gigabit per second, e.g., 7 Gigabit per second, or any other rate.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments are described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Some embodiments may involve wireless communications according to one or more other wireless communication standards. Examples of other wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, IEEE 802.11 ah, IEEE 802.11ay standards, or other IEEE 802.11 standards, Wi-Fi Alliance (WFA) wireless communication standards, such as, Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above.

Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

Exemplary aspects are directed toward:

A wireless communications device acting as a reverse direction (RD) initiator, the wireless communications device comprising: a radio frequency (RF) component(s) to: send a first aggregated media access control (MAC) protocol data unit (MPDU) (A-MPDU) to a RD responder; receive a BA frame from the RD responder; a controller in communication with the (RF) component(s), the controller to: generate the first A-MPDU frame to begin an RD session; read the BA frame, wherein the BA frame comprises RDG/More PPDU field that indicates whether the RD responder will send a second A-MPDU frame.

Any of the one or more above aspects, wherein a QoS null frame is not sent with the BA frame from the RD responder.

Any of the one or more above aspects, wherein the RDG/More PPDU field replaces an unused field in the BA frame.

Any of the one or more above aspects, wherein the unused field is a HTC/Order field.

Any of the one or more above aspects, further comprising the controller to receive the second A-MPDU frame from the RF component(s).

Any of the one or more above aspects, further comprising the controller to generate a second BA frame to acknowledge receipt of the second A-MPDU frame received from the RD responder.

Any of the one or more above aspects, further comprising the RF component(s) to transmit the second BA frame to the RD responder.

Any of the one or more above aspects, wherein the RD session occurs during a transmit opportunity (TxOP) owned by the RD initiator.

Any of the one or more above aspects, further comprising the controller to determine the TxOP can be used by the RD responder in the RD session.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or

a new field in an enhanced DMG (EDMG) physical layer convergence procedure (PLCP) Header-A.

A method comprising: a radio frequency (RF) component(s) sending a first aggregated media access control (MAC) protocol data unit (MPDU) (A-MPDU) to a RD responder, wherein the A-MPDU begins a RD session; and the RF component(s) receiving a BA frame from the RD responder, wherein the BA frame comprises a RDG/More PPDU field that indicates whether the RD responder will send a second A-MPDU frame.

Any of the one or more above aspects, wherein a QoS null frame is not sent with the BA frame from the RD responder.

Any of the one or more above aspects, wherein the RDG/More PPDU field replaces an unused field in the BA frame.

Any of the one or more above aspects, wherein the unused field is a HTC/Order field.

Any of the one or more above aspects, further comprising receiving the second A-MPDU frame from the RF component(s).

Any of the one or more above aspects, further comprising generating a second BA frame to acknowledge receipt of the second A-MPDU frame received from the RD responder.

Any of the one or more above aspects, further comprising transmitting the second BA frame to the RD responder.

Any of the one or more above aspects, wherein the RD session occurs during a transmit opportunity (TxOP) owned by the RD initiator.

Any of the one or more above aspects, further comprising determining the TxOP can be used by the RD responder in the RD session.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or a new field in an enhanced DMG (EDMG) physical layer convergence procedure (PLCP) Header-A.

A non-transitory information storage media having stored thereon one or more instructions, that when executed by one or more processors, cause a wireless communications device to perform a method, the method comprising: a radio frequency (RF) component(s) sending a first aggregated media access control (MAC) protocol data unit (MPDU) (A-MPDU) to a RD responder, wherein the A-MPDU begins a RD session; and the RF component(s) receiving a BA frame from the RD responder, wherein the BA frame comprises a RDG/More PPDU field that indicates whether the RD responder will send a second A-MPDU frame.

Any of the one or more above aspects, wherein a QoS null frame is not sent with the BA frame from the RD responder.

Any of the one or more above aspects, wherein the RDG/More PPDU field replaces an unused field in the BA frame.

Any of the one or more above aspects, wherein the unused field is a HTC/Order field.

Any of the one or more above aspects, the method further comprising receiving the second A-MPDU frame from the RF component(s).

Any of the one or more above aspects, the method further comprising generating a second BA frame to acknowledge receipt of the second A-MPDU frame received from the RD responder.

Any of the one or more above aspects, the method further comprising transmitting the second BA frame to the RD responder.

Any of the one or more above aspects, wherein the RD session occurs during a transmit opportunity (TxOP) owned by the RD initiator.

Any of the one or more above aspects, the method further comprising determining the TxOP can be used by the RD responder in the RD session.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or a new field in an enhanced DMG (EDMG) physical layer convergence procedure (PLCP) Header-A.

A wireless communications device comprising: means for sending a first aggregated wireless communications device access control (MAC) protocol data unit (MPDU) (A-MPDU) to a RD responder, wherein the A-MPDU begins a RD session; and means for receiving a BA frame from the RD responder, wherein the BA frame comprises a RDG/More PPDU field that indicates whether the RD responder will send a second A-MPDU frame.

Any of the one or more above aspects, wherein a QoS null frame is not sent with the BA frame from the RD responder.

Any of the one or more above aspects, wherein the RDG/More PPDU field replaces an unused field in the BA frame.

Any of the one or more above aspects, wherein the unused field is a HTC/Order field.

Any of the one or more above aspects, further comprising means for receiving the second A-MPDU frame from the RF component(s).

Any of the one or more above aspects, further comprising means for generating a second BA frame to acknowledge receipt of the second A-MPDU frame received from the RD responder.

Any of the one or more above aspects, further comprising means for transmitting the second BA frame to the RD responder.

Any of the one or more above aspects, wherein the RD session occurs during a transmit opportunity (TxOP) owned by the RD initiator.

Any of the one or more above aspects, further comprising means for determining the TxOP can be used by the RD responder in the RD session.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or

a new field in an enhanced DMG (EDMG) physical layer convergence procedure (PLCP) Header-A.

A wireless communications device acting as a reverse direction (RD) responder, the wireless communications device comprising: a radio frequency (RF) component(s) to: receive a first aggregated media access control (MAC) protocol data unit (MPDU) (A-MPDU) from a RD initiator; send a BA frame from the RD responder; a controller in communication with the (RF) component(s), the controller to: read the first A-MPDU frame to begin an RD session; determine if data is available to send during the RD session generate the BA frame, wherein the BA frame comprises a RDG/More PPDU field that indicates whether the RD responder will send a second A-MPDU frame.

Any of the one or more above aspects, wherein a QoS null frame is not sent with the BA frame to the RD initiator.

Any of the one or more above aspects, wherein the RDG/More PPDU field replaces an unused field in the BA frame.

Any of the one or more above aspects, wherein the unused field is a HTC/Order field.

Any of the one or more above aspects, further comprising the controller to send the second A-MPDU frame from the RF component(s).

Any of the one or more above aspects, further comprising the RF component(s) to receive a second BA frame to acknowledge receipt of the second A-MPDU frame received from the RD initiator.

Any of the one or more above aspects, further comprising the controller to read the second BA frame.

Any of the one or more above aspects, wherein the RD session occurs during a transmit opportunity (TxOP) owned by the RD initiator.

Any of the one or more above aspects, further comprising the controller to determine that data is available in a buffer.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or a new field in an enhanced DMG (EDMG) physical layer convergence procedure (PLCP) Header-A.

A method comprising: a radio frequency (RF) component(s) receiving a first aggregated media access control (MAC) protocol data unit (MPDU) (A-MPDU) from a RD initiator; a controller determining if data is available to send during the RD session; and the RF component(s) sending a BA frame from the RD responder, wherein the BA frame comprises a RDG/More PPDU field that indicates whether the RD responder will send a second A-MPDU frame.

Any of the one or more above aspects, wherein a QoS null frame is not sent with the BA frame to the RD initiator.

Any of the one or more above aspects, wherein the RDG/More PPDU field replaces an unused field in the BA frame.

Any of the one or more above aspects, wherein the unused field is a HTC/Order field.

Any of the one or more above aspects, further comprising sending the second A-MPDU frame from the RF component(s).

Any of the one or more above aspects, further comprising receiving a second BA frame to acknowledge receipt of the second A-MPDU frame received from the RD initiator.

Any of the one or more above aspects, further comprising reading the second BA frame.

Any of the one or more above aspects, wherein the RD session occurs during a transmit opportunity (TxOP) owned by the RD initiator.

Any of the one or more above aspects, further comprising determining that data is available in a buffer.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or a new field in an enhanced DMG (EDMG) physical layer convergence procedure (PLCP) Header-A.

A non-transitory information storage media having stored thereon one or more instructions, that when executed by one or more processors, cause a wireless communications device to perform a method, the method comprising: a radio frequency (RF) component(s) receiving a first aggregated media access control (MAC) protocol data unit (MPDU) (A-MPDU) from a RD initiator; a controller determining if data is available to send during the RD session; and the RF component(s) sending a BA frame from the RD responder, wherein the BA frame comprises a RDG/More PPDU field that indicates whether the RD responder will send a second A-MPDU frame.

Any of the one or more above aspects, wherein a QoS null frame is not sent with the BA frame to the RD initiator.

Any of the one or more above aspects, wherein the RDG/More PPDU field replaces an unused field in the BA frame.

Any of the one or more above aspects, wherein the unused field is a HTC/Order field.

Any of the one or more above aspects, the method further comprising sending the second A-MPDU frame from the RF component(s).

Any of the one or more above aspects, the method further comprising receiving a second BA frame to acknowledge receipt of the second A-MPDU frame received from the RD initiator.

Any of the one or more above aspects, the method further comprising reading the second BA frame.

Any of the one or more above aspects, wherein the RD session occurs during a transmit opportunity (TxOP) owned by the RD initiator.

Any of the one or more above aspects, the method further comprising determining that data is available in a buffer.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or

a new field in an enhanced DMG (EDMG) physical layer convergence procedure (PLCP) Header-A.

A wireless communications comprising: means for receiving a first aggregated wireless communications device access control (MAC) protocol data unit (MPDU) (A-MPDU) from a RD initiator; means for determining if data is available to send during the RD session; and means for sending a BA frame from the RD responder, wherein the BA frame comprises a RDG/More PPDU field that indicates whether the RD responder will send a second A-MPDU frame.

Any of the one or more above aspects, wherein a QoS null frame is not sent with the BA frame to the RD initiator.

Any of the one or more above aspects, wherein the RDG/More PPDU field replaces an unused field in the BA frame.

Any of the one or more above aspects, wherein the unused field is a HTC/Order field.

Any of the one or more above aspects, further comprising means for sending the second A-MPDU frame from the RF component(s).

Any of the one or more above aspects, further comprising means for receiving a second BA frame to acknowledge receipt of the second A-MPDU frame received from the RD initiator.

Any of the one or more above aspects, further comprising means for reading the second BA frame.

Any of the one or more above aspects, wherein the RD session occurs during a transmit opportunity (TxOP) owned by the RD initiator.

Any of the one or more above aspects, further comprising means for determining that data is available in a buffer.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or a new field in an enhanced DMG (EDMG) physical layer convergence procedure (PLCP) Header-A.

A wireless communications device acting as a reverse direction (RD) initiator, the wireless communications device comprising: a radio frequency (RF) component(s) to: send a first aggregated media access control (MAC) protocol data unit (MPDU) (A-MPDU) to a RD responder; receiving a BA frame from the RD responder; a controller in communication with the (RF) component(s), the controller to: generate the first A-MPDU frame to begin an RD session; and read the BA frame, wherein the BA frame comprises RDG/More PPDU field that indicates whether the RD responder will send a second A-MPDU frame.

Any of the one or more above aspects, wherein a QoS null frame is not sent with the BA frame from the RD responder.

Any of the one or more above aspects, wherein the RDG/More PPDU field replaces an unused field in the BA frame.

Any of the one or more above aspects, wherein the unused field is a HTC/Order field.

Any of the one or more above aspects, further comprising the controller to receive the second A-MPDU frame from the RF component(s).

Any of the one or more above aspects, further comprising the controller to generate a second BA frame to acknowledge receipt of the second A-MPDU frame received from the RD responder.

Any of the one or more above aspects, further comprising the RF component(s) to transmit the second BA frame to the RD responder.

Any of the one or more above aspects, wherein the RD session occurs during a transmit opportunity (TxOP) owned by the RD initiator.

Any of the one or more above aspects, further comprising the controller to determine the TxOP can be used by the RD responder in the RD session.

Any of the one or more above aspects, wherein the RDG/More PPDU field is set in one of: a turnaround field in a directive multi-gigabit (DMG) single channel (SC) mode header; or a field in a directive multi-gigabit (DMG) control mode header; or a new field in an enhanced DMG (EDMG) physical layer convergence procedure (PLCP) Header-A.

A method to be performed at a wireless station, the method comprising: a controller, of the wireless station, generating a first aggregated media access control (MAC) protocol data unit (MPDU) (A-MPDU) frame to begin an RD session; a radio frequency (RF) component(s), of the wireless station, sending the A-MPDU frame to a RD responder; in response to the first A-MPDU frame, the RF component(s) receiving a BA frame from the RD responder; and the controller reading the BA frame, wherein the BA frame comprises RDG/More PPDU field that indicates whether the RD responder will send a second A-MPDU frame.

Any of the one or more above aspects, wherein a QoS null frame is not sent with the BA frame from the RD responder.

Any of the one or more above aspects, wherein the RDG/More PPDU field replaces an unused field in the BA frame, and wherein the unused field is a HTC/Order field.

Any of the one or more above aspects, further comprising: the controller receiving the second A-MPDU frame from the RF component(s); the controller generating a second BA frame to acknowledge receipt of the second A-MPDU frame received from the RD responder; and the RF component(s) transmitting the second BA frame to the RD responder.

Any of the one or more above aspects, wherein the RD session occurs during a transmit opportunity (TxOP) owned by the RD initiator, the method further comprising the controller determining the TxOP can be used by the RD responder in the RD session.

A non-transitory information storage media having stored thereon one or more instructions, that when executed by one or more processors, cause a station (STA) to perform a method, the method comprising: generating a first aggregated media access control (MAC) protocol data unit (MPDU) (A-MPDU) frame to begin an RD session; sending the first A-MPDU frame to a RD responder; in response to the first A-MPDU frame, receiving a BA frame from the RD responder; and reading the BA frame, wherein the BA frame comprises RDG/More PPDU field that indicates whether the RD responder will send a second A-MPDU frame.

Any of the one or more above aspects, wherein a QoS null frame is not sent with the BA frame from the RD responder.

Any of the one or more above aspects, wherein the RDG/More PPDU field replaces an unused field in the BA frame, and wherein the unused field is a HTC/Order field.

Any of the one or more above aspects, the method further comprising: the controller receiving the second A-MPDU frame from the RF component(s); the controller generating a second BA frame to acknowledge receipt of the second A-MPDU frame received from the RD responder; and the RF component(s) transmitting the second BA frame to the RD responder.

Any of the one or more above aspects, wherein the RD session occurs during a transmit opportunity (TxOP) owned by the RD initiator, the method further comprising the controller determining the TxOP can be used by the RD responder in the RD session.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

What is claimed is:

1. A wireless communications device acting as a reverse direction (RD) initiator, the wireless communications device comprising:
a radio frequency (RF) component(s) to:
send a first aggregated media access control (MAC) protocol data unit (MPDU) (A-MPDU) to a RD responder;
receive a BA frame from the RD responder;
a controller in communication with the (RF) component(s), the controller to:
generate the first A-MPDU frame to begin an RD session; and
read the BA frame, wherein the BA frame comprises RDG/More PPDU field that indicates whether the RD responder will send a second A-MPDU frame.

2. The wireless communications device of claim 1, wherein a QoS null frame is not sent with the BA frame from the RD responder.

3. The wireless communications device of claim 2, wherein the RDG/More PPDU field replaces an unused field in the BA frame.

4. The wireless communications device of claim 3, wherein the unused field is a HTC/Order field.

5. The wireless communications device of claim 4, further comprising the controller to receive the second A-MPDU frame from the RF component(s).

6. The wireless communications device of claim 5, further comprising the controller to generate a second BA frame to acknowledge receipt of the second A-MPDU frame received from the RD responder.

7. The wireless communications device of claim 6, further comprising the RF component(s) to transmit the second BA frame to the RD responder.

8. The wireless communications device of claim 7, wherein the RD session occurs during a transmit opportunity (TxOP) owned by the RD initiator.

9. The wireless communications device of claim 8, further comprising the controller to determine the TxOP can be used by the RD responder in the RD session.

10. The wireless communications device of claim 5, wherein the RDG/More PPDU field is set in one of:
a turnaround field in a directive multi-gigabit (DMG) single channel (SC) mode header; or
a field in a directive multi-gigabit (DMG) control mode header; or
a new field in an enhanced DMG (EDMG) physical layer convergence procedure (PLCP) Header-A.

11. A method to be performed at a wireless station, the method comprising:
a controller, of the wireless station, generating a first aggregated media access control (MAC) protocol data unit (MPDU) (A-MPDU) frame to begin an RD session;
a radio frequency (RF) component(s), of the wireless station, sending the A-MPDU frame to a RD responder;
in response to the first A-MPDU frame, the RF component(s) receiving a BA frame from the RD responder; and
the controller reading the BA frame, wherein the BA frame comprises RDG/More PPDU field that indicates whether the RD responder will send a second A-MPDU frame.

12. The method of claim 11, wherein a QoS null frame is not sent with the BA frame from the RD responder.

13. The method of claim 12, wherein the RDG/More PPDU field replaces an unused field in the BA frame, and wherein the unused field is a HTC/Order field.

14. The method of claim 13, further comprising:
the controller receiving the second A-MPDU frame from the RF component(s);
the controller generating a second BA frame to acknowledge receipt of the second A-MPDU frame received from the RD responder; and
the RF component(s) transmitting the second BA frame to the RD responder.

15. The method of claim 14, wherein the RD session occurs during a transmit opportunity (TxOP) owned by the RD initiator, the method further comprising the controller determining the TxOP can be used by the RD responder in the RD session.

16. A non-transitory information storage media having stored thereon one or more instructions, that when executed by one or more processors, cause a station (STA) to perform a method, the method comprising:
generating a first aggregated media access control (MAC) protocol data unit (MPDU) (A-MPDU) frame to begin an RD session;
sending the first A-MPDU frame to a RD responder;
in response to the first A-MPDU frame, receiving a BA frame from the RD responder; and
reading the BA frame, wherein the BA frame comprises RDG/More PPDU field that indicates whether the RD responder will send a second A-MPDU frame.

17. The media of claim 16, wherein a QoS null frame is not sent with the BA frame from the RD responder.

18. The media of claim 16, wherein the RDG/More PPDU field replaces an unused field in the BA frame, and wherein the unused field is a HTC/Order field.

19. The media of claim 18, the method further comprising:
the controller receiving the second A-MPDU frame from the RF component(s);
the controller generating a second BA frame to acknowledge receipt of the second A-MPDU frame received from the RD responder; and
the RF component(s) transmitting the second BA frame to the RD responder.

20. The media of claim 16, wherein the RD session occurs during a transmit opportunity (TxOP) owned by the RD initiator, the method further comprising the controller determining the TxOP can be used by the RD responder in the RD session.
